(19) United States
(12) Patent Application Publication
(10) Pub. No.: US 2004/0204196 A1
(43) Pub. Date: Oct. 14, 2004

(54) Cellular telephone lighting system and method

(76) Inventors: Lester Dunican, Seal Beach, CA (US); Quentin Humphrey, Seal Beach, CA (US)

Correspondence Address: KENNETH L. NASH, P.O. BOX 680106, HOUSTON, TX, 77268-0106, US

(21) Appl. No.: 10/310,272

(22) Filed: Dec. 5, 2002

(51) Int. Cl. H04B 1/38; H04M 1/00

(52) U.S. Cl. 455/575.1; 455/572; 455/90.3

(57) ABSTRACT

A cellular telephone lighting system and method is provided which in one embodiment provides a light that may be mounted to any cellular telephone which has a replaceable battery pack. The light is preferably produced utilizing a high intensity, low current drain, light emitting diode. The circuitry for the light may be built into a compartment in the battery pack that may be raised slightly to provide the additional room for the components. A switch is mounted to the battery pack for controlling the light.

### TECHNICAL FIELD

The present invention relates generally to a flashlight for cellular telephones and, in a preferred embodiment, provides a method for adapting a flashlight to exiting cellular telephones.

### BACKGROUND

While lights and flashlights have been utilized with telephones as discussed below, there are numerous problems with prior art devices. For instance, adding a built in flashlight for cellular telephones has required building a newly designed case and electronics. Thus for instance, the prior art does not disclose means for efficiently mounting a flashlight to the approximately one hundred million existing cellular telephones in the United States alone. Moreover, prior art flashlights provide a very weak light and/or utilize significant amounts of power.

U.S. Pat. No. 6,254,249 B1, issued Jul. 3, 2001, to Kim et al., discloses a cellular phone with lamps comprising first, second and third illuminating lamps, an illuminating button, a cover open/close detecting unit and a control unit, for use as memorandum reading and flash light functions and for use as a lamp for illuminating an entire area of a key pad, thereby simplifying structure and reducing thickness of the cellular phone.

U.S. Pat. No. 5,901,206, issued May 4, 1999, to M. T. Soon, discloses a portable telephone with flashlight that includes a portable telephone powered by a battery and has a front face, a back face, a top face, a bottom face, a pair of side faces, and a flashlight disposed on the portable telephone. The flashlight extends axially from the top face of the portable telephone, in proximity to one side face of the pair of side a faces of the portable telephone. The flashlight includes a reflector that is substantially flush with the top face of the portable telephone, a bulb that is cradled axially in the reflector of the flashlight so as to project a beam of light axially of the portable telephone, and an ON/OFF switch that is disposed on the one side face of the pair of side faces of the portable telephone, in proximity to the top face of the portable telephone. The portable telephone functions as a handle for the flashlight to be gripped in the palm of a hand, with the flashlight being activated, and projecting a beam of light axially of the portable telephone, when the portable telephone is gripped in the palm of the hand and a finger of the hand depresses the ON/OFF switch of the flashlight.

U.S. Pat. No. 5,587,645, issued Dec. 24, 1996, to E. Sciammarella et al., discloses a battery charger having a night light for use with a cordless telephone. The battery charger is energized by being plugged into a standard AC outlet and includes a cradle for receiving a cordless telephone handset having rechargeable batteries. The battery charger includes a photo transistor for detecting the level of light impinging on the battery charger and a lamp for providing illumination. When AC power is cut off and the photo transistor detects that the light level is below a predetermined level, the lamp is powered by the handset battery to provide illumination and to enable a user to locate the handset during low light conditions while it is being charged.

U.S. Pat. No. 3,821,539, issued Jun. 28, 1974, to J. Kleinman, discloses a flashlight in the form of a simulated telephone handset. The simulated telephone is, nonoperational as a telephone but acts a novelty item that may be used as a flashlight.

The above cited prior art does not disclose means for adapting any cellular phone for use as a flashlight or provide the useful functions and methods as taught herein. Consequently, there remains a need to provide an improved cellular telephone flashlight and method. Those of skill in the art will appreciate the present invention which addresses the above and other problems.

### SUMMARY OF THE INVENTION

An objective of the present invention is to provide an improved cellular telephone flashlight assembly and method.

Another objective of an embodiment of this invention is to provide a cellular telephone flashlight that may be mounted to an existing cellular telephone.

These and other objectives, features, and advantages of the present invention will become apparent from the drawings, the descriptions given herein, and the appended claims. However, it will be understood that above-listed objectives and/or advantages of the invention are intended only as an aid in quickly understanding aspects of the invention, are not intended to limit the invention in any way, and therefore do not form a comprehensive or restrictive list of objectives, and/or features, and/or advantages.

Accordingly, the invention comprises, in one embodiment thereof, a lighting system for a cellular telephone which may include one or more elements such as, for instance, a replaceable battery pack adapted for use with the cellular telephone, at least one light mounted to the replaceable battery pack, a control mounted to the replaceable battery pack, and electrical connections for the battery pack for electrically connecting the at least one light and the control to power within the battery pack such that the switch is operable for controlling the at least one light. In one embodiment, the light further comprises a light emitting diode and the control comprises an on-off switch.

In one embodiment, the control is operable for variably controlling the light such that at least two or more levels of lighting brightness are selectable. The lighting assembly may further comprise a raised portion of the battery pack defining therein a compartment for the lighting assembly. In another embodiment, the lighting assembly may further comprise any type of movement sensor such as optical, acoustic, ultrasonic, infrared or the like as may be used to implement other functions for the cellular telephone.

In operation, a method is provided for mounting a light into an already existing cellular telephone which may comprise one or more steps such as, for instance, mounting the light in a replaceable battery pack and inserting the replaceable battery pack into the existing cellular telephone. The method may further comprise mounting a light controller in the battery pack for operating the light. The light controller may be of different types such as a switch operable to turn the light on or off, a movement sensor, a variable resistor for selectively controlling a variable intensity of the light, or other constructions.

In another embodiment, the invention comprises a cellular phone which may comprise a replaceable battery pack, a manually operated controller secured to a battery pack, and circuitry mounted in the replaceable battery pack operable to transmit a signal in response to selective manual operation of the manually operated controller. For instance, the signal may comprise a flashlight beam produced by a light emitting diode for transmitting the signal and the manually operated controller may comprise an on-off switch.

This summary is not intended to be a limitation with respect to the features of the invention as claimed, and this and other objects can be more readily observed and understood in the detailed description of the preferred embodiment and in the claims.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is an elevational side view showing a cellular telephone with a battery pack mounted flashlight installed therein in accord with the present invention;

FIG. 2 is an elevational view of a typical battery pack for a cellular telephone; and

FIG. 3 is an electronic schematic for electronics utilized in a preferred embodiment of the invention.

While the present invention will be described in connection with presently preferred embodiments, it will be understood that it is not intended to limit the invention to those embodiments. On the contrary, it is intended to cover all alternatives, modifications, and equivalents included within the spirit of the invention.

### GENERAL DESCRIPTION OF PREFERRED EMBODIMENTS FOR CARRYING OUT THE INVENTION

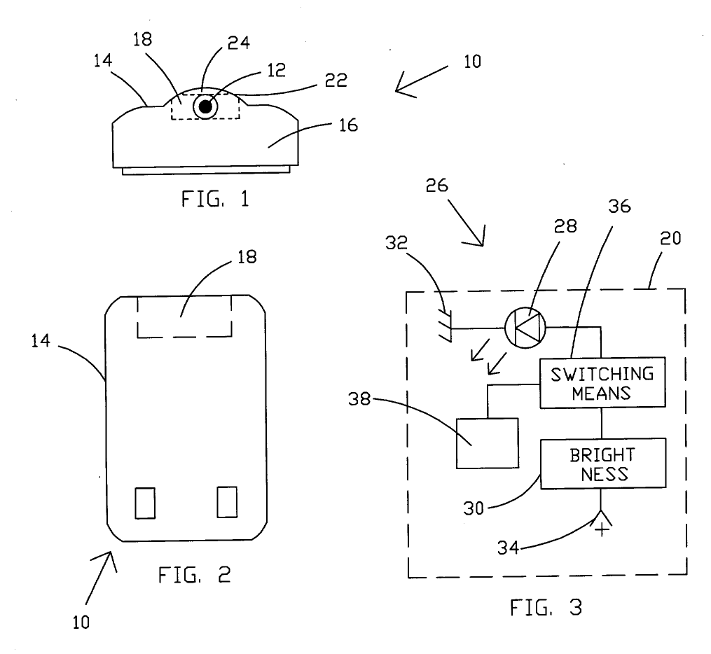

Referring now to the drawings and, more particularly to FIGS. 1 and 2, there is shown battery pack light system 10 comprising lighting element(s) 12 that may be preferably built into a removable battery pack 14 for cellular telephone 16. It will be understood that most cellular telephones have a removable battery pack 14 that must upon occasion be replaced. The present invention provides for a lighting assembly and/or other novel elements mounted within compartment 18 of the battery pack, such as battery pack 14, itself. The lighting assembly may be manufactured very inexpensively and sturdily by solid state construction on a single circuit board 20 that is easily mounted within compartment 18 of battery pack 14. Thus, when it becomes necessary for the user to replace the battery pack, or earlier if desired, the user may elect to obtain a built-in flashlight element. The option may also be utilized with new phone purchases whereby consumers may be provided with an option for a built-in flashlight, if desired.

Compartment 18 may be formed, if desired, within a slightly raised hump portion 22 of battery pack 14. Hump portion 22 may also include a button 24 or any other suitable switching means as desired for operating lighting system 10 of the present invention. However, compartment 18 may be formed in any suitable portion of the battery pack as desired.

FIG. 3 provides one possible embodiment of a circuit diagram for the lighting system 10 of the present invention. In a preferred embodiment, the lighting element comprises one or more light emitting diodes such as light emitting diode 28. Light emitting diodes are very efficient, produce very little heat, draw little current, and may be quite bright. For instance, a single, suitable, low-cost light emitting diode may be bright enough to be visible from several hundred yards and yet produce very little drain on the power. However, other lighting elements could also be utilized if desired.

Brightness means 30 may comprise several embodiments. In the simplest embodiment, brightness means 30 may be a simple resistor selected for producing the desired level of light and current drain. Brightness means 30 may provide for adjustable lighting with a variable resistance that may be suitable for different functions. For instance, in some cases, it may be desirable that the charging cellular telephone selectively act as either a night light or a flashlight. Thus, by pushing switching means 36, which may comprise button 22, twice a lower level of lighting may be produced whereby lighting system 10 provides a night light during battery charging or any other time as desired. Since battery pack 14 contains the battery, connections 32 and 34 preferably connect directly to battery pack 14. While button 22 is a preferred means for turning diode 28 on an off, other means such as rotatable knobs, pressure sensitive solid state switches, and the like may be utilized.

While the present invention mounts a lighting assembly in the battery pack, other features could also be mounted therein for operation alone or in conjunction with lighting system. For instance, switching means 36 may comprise a movement sensor for turning on said light which may be useful at night for finding the cellular telephone or as a night lite that turns off when no movement is detected. Movement sensor may also be utilized with an auditory signal 38 to provide a moveable hotel burglar alarm. Thus, other elements and features may also be mounted to the cellular telephone by means of the battery pack in accord with the present invention.

Thus, the foregoing disclosure and description of the invention is therefore illustrative and explanatory of one or more presently preferred embodiments of the invention and variations thereof, and it will be appreciated by those skilled in the art that various changes in the design, organization, order of operation, means of operation, equipment structures and location, methodology, and use of mechanical equivalents, as well as in the details of the illustrated construction or combinations of features of the various elements, may be made without departing from the spirit of the invention. As well, the drawings are intended to describe the concepts of the invention so that the presently preferred embodiments of the invention will be plainly disclosed to one of skill in the art but are not intended to be manufacturing level drawings or renditions of final products and may include simplified conceptual views as desired for easier and quicker understanding or explanation of the invention. It will be seen that various changes and alternatives may be used that are contained within the spirit of the invention. Moreover, it will be understood that various directions such as “upper,” “lower,” “bottom,” “top,” “left,” “right,” “inwardly,” “outwardly,” and so forth are made only with respect to easier explanation in conjunction with the drawings and that the components may be oriented differently, for instance, during transportation and manufacturing as well as operation. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

It is claimed:

1. A lighting system for a cellular telephone, comprising:
a replaceable battery pack adapted for use with said cellular telephone;
at least one light mounted to said replaceable battery pack;
a control mounted to said replaceable battery pack;
electrical connections for said battery pack for electrically connecting said at least one light and said control to power within said battery pack such that a switch is operable for controlling said at least one light.

2. The lighting assembly of claim 1, wherein said light further comprises a light emitting diode.

3. The lighting assembly of claim 1, wherein said control comprises an on-off switch.

4. The lighting assembly of claim 1, wherein said control is operable for variably controlling said light such that at least two or more levels of lighting brightness are selectable.

5. The lighting assembly of claim 1, further comprising a raised portion of said battery pack defining therein a compartment for said lighting assembly.

6. The lighting assembly of claim 1, further comprising a movement sensor.

7. A method for mounting a light in an existing cellular telephone, comprising:
mounting said light in a replaceable battery pack; and
inserting said replaceable battery pack into said existing cellular telephone.

8. The method of claim 7, further comprising mounting a light controller in said battery pack for operating said light.

9. The method of claim 7, wherein said light controller is a switch operable to turn said light on or off.

10. The method of claim 7, wherein said light controller is a movement sensor.

11. The method of claim 7, wherein said light controller is a variable resistor for selectively controlling a variable intensity of said light.

12. The method of claim 7, further providing that said light comprises at least one light emitting diode.

13. The method of claim 7, further comprising providing that said battery pack is rechargeable.

14. The method of claim 8 wherein said light controller is mounted within said battery pack.

15. A cellular phone, comprising:
a replaceable battery pack;
a manually operated controller secured to a battery pack; and
circuitry mounted in said replaceable battery pack operable to transmit a signal in response to selective manual operation of said manually operated controller.

16. The cellular phone of claim 15, wherein said signal comprises a flashlight beam.

17. The cellular phone of claim 16, further comprising a light emitting diode for transmitting said signal.

18. The cellular phone of claim 15, wherein said manually operated controller comprises
an on-off switch.

19. The cellular phone of claim 15, wherein said manually operated controller comprises a variable resistance control.

20. The method of claim 15, wherein said signal comprises a motion sensor signal.
